(19) United States
(12) Patent Application Publication
(10) Pub. No.: US 2016/0086377 A1
(43) Pub. Date: Mar. 24, 2016

(54) DETERMINING AN IMAGE TARGET'S SUITABILITY FOR COLOR TRANSFER IN AN AUGMENTED REALITY ENVIRONMENT

(71) Applicant: QUALCOMM Incorporated, San Diego, CA (US)

(72) Inventors: Erick Mendez Mendez, Vienna (AT); Gerhard Reitmayr, Vienna (AT)

(21) Appl. No.: 14/491,356

(22) Filed: Sep. 19, 2014

(51) Int. Cl. G06T 19/00; G06T 7/40; G06K 9/46; G09G 5/02

(52) U.S. Cl. CPC G06T 19/006; G09G 5/02; G06T 7/408; G06K 9/4652

(57) ABSTRACT

Disclosed are example methods, apparatuses, and articles of manufacture for determining and providing a suitability of an image target for Color Transfer. In an example embodiment, a method, which may be implemented using a computing device, may comprise: receiving image data representative of the image target; determining a suitability of the image target for Color Transfer based, at least in part, on one or more colors of the image data; and providing an indication indicative of the suitability of the image target for Color Transfer.

### FIELD

The subject matter disclosed herein relates to electronic devices and, more particularly, to methods, apparatuses, and articles of manufacture for use therewith in developing augmented reality environments or the like.

### BACKGROUND

With the Augmented Reality technology, a visible virtual object may be superimposed on an image or a video feed of a real-world scene, such that in the output image or video feed, the virtual object appears to be part of the real-world scene. Multiple known techniques may be used to make the virtual object appear realistically as part of the real-world scene. For example, the camera pose may be tracked from one image to another, or from one frame to another in the case of video feeds, such that the pose of the virtual object may be adjusted accordingly to make the virtual object appear as part of the real-world scene.

Techniques known as Ground Truth-based Color Transfer (hereinafter “Color Transfer”) may be used to track changes in the lighting conditions in the images or the video feed of the real-world scene based on a Ground Truth image reflecting apparent colors of the real-world scene in a neutral lighting condition, and apply a color change to the virtual object to reflect the changes in the lighting conditions in the real-world scene, thus making the virtual object appear more realistically as part of the real-world scene. An example of a Color Transfer technique is described in the U.S. patent application Ser. No. 14/210,053.

### SUMMARY

An embodiment disclosed herein may include a method for providing a suitability for Color Transfer of an image target, the method comprising, with a computing device: receiving image data representative of the image target; determining a suitability of the image target for Color Transfer based, at least in part, on one or more colors of the image data; and providing an indication indicative of the suitability of the image target for Color Transfer.

Another embodiment disclosed herein may include an apparatus for providing a suitability for Color Transfer of an image target, comprising: a memory; and a processor to: receive image data representative of the image target, determine a suitability of the image target for Color Transfer based, at least in part, on one or more colors of the image data, and provide an indication indicative of the suitability of the image target for Color Transfer.

A further embodiment disclosed herein may include an apparatus for providing a suitability for Color Transfer of an image target, comprising: means for receiving image data representative of the image target; means for determining a suitability of the image target for Color Transfer based, at least in part, on one or more colors of the image data; and means for providing an indication indicative of the suitability of the image target for Color Transfer.

An additional embodiment disclosed herein may include a non-transitory computer-readable medium comprising code which, when executed by a processor, causes the processor to perform a method comprising: receiving image data representative of the image target; determining a suitability of the image target for Color Transfer based, at least in part, on one or more colors of the image data; and providing an indication indicative of the suitability of the image target for Color Transfer.

### BRIEF DESCRIPTION OF THE DRAWINGS

FIG. 1 illustrates an device for determining and providing a suitability of an image target for Color Transfer, in accordance with an example embodiment.

FIG. 2 is a flowchart illustrating an example method for determining and providing suitability of an image target for Color Transfer, in accordance with an example embodiment.

FIGS. 3A and 3B illustrate two example image targets with different suitability for Color Transfer at three scales, in accordance with an example embodiment.

FIG. 4 is a block diagram illustrating some example factors that may be considered, at least in part, in determining and providing a suitability for Color Transfer, in accordance with an example embodiment.

### DETAILED DESCRIPTION

As mentioned, techniques known as Ground Truth-based Color Transfer (hereinafter “Color Transfer”) may be used to track changes in the lighting conditions in the images or the video feed of the real-world scene based on a Ground Truth image reflecting apparent colors of the real-world scene in a neutral lighting condition, and apply a color change to the virtual object to reflect the changes in the lighting conditions in the real-world scene, thus making the virtual object appear more realistically as part of the real-world scene. An example of a Color Transfer technique is described in the U.S. patent application Ser. No. 14/210,053.

Images or video feeds of real-world scenes, on which virtual objects may be superimposed, may be collectively referred to as image targets. Certain Color Transfer techniques may work better with some image targets than with others, for example depending on certain properties of the image targets. Accordingly, it may be useful to determine an image targets' suitability for Color Transfer. For example, it may be useful to determine and present an image targets' suitability rating for Color Transfer during the development of an augmented reality or other like computer-based imaging application, product, etc.

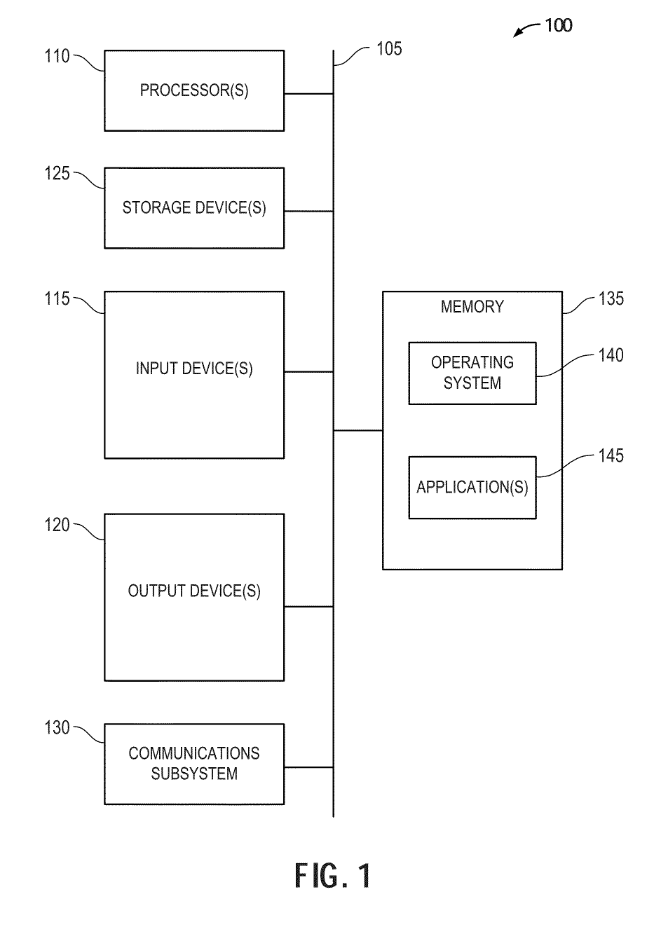

An example device 100 for determining a suitability of an image target for Color Transfer and providing an indication (e.g., a rating) of the determined suitability is illustrated in FIG. 1. The device as used herein (e.g., device 100) may be a: mobile device, wireless device, cell phone, personal digital assistant, mobile computer, wearable device (e.g., watch, head mounted display, virtual reality glasses, etc.), tablet, personal computer, laptop computer, or any type of device that has processing capabilities. As used herein, a mobile device may be any portable, or movable device or machine that is configurable to acquire wireless signals transmitted from, and transmit wireless signals to, one or more wireless communication devices or networks. Thus, by way of example but not limitation, the device 100 may include a radio device, a cellular telephone device, a computing device, a personal communication system device, or other like movable wireless communication equipped device, appliance, or machine.

The device 100 is shown comprising hardware elements that can be electrically coupled via a bus 105 (or may otherwise be in communication, as appropriate). The hardware elements may include one or more processors 110, including without limitation one or more general-purpose processors and/or one or more special-purpose processors (such as digital signal processing chips, graphics acceleration processors, and/or the like); one or more input devices 115, which include without limitation a mouse, a keyboard, keypad, touch-screen, camera, microphone and/or the like; and one or more output devices 120, which include without limitation a display device, a speaker, a printer, and/or the like.

The device 100 may further include (and/or be in communication with) one or more non-transitory storage devices 125, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The device may also include a communication subsystem 130, which can include without limitation a modem, a network card (wireless or wired), an infrared communication device, a wireless communication device and/or chipset (such as a Bluetooth device, an 802.11 device, a Wi-Fi device, a WiMAX device, cellular communication facilities, etc.), and/or the like. The communications subsystem 130 may permit data to be exchanged with a network, other devices, and/or any other devices described herein. In one embodiment, the device 100 may further comprise a memory 135, which can include a RAM or ROM device, as described above. It should be appreciated that device 100 may be a mobile device or a non-mobile device, and may have wireless and/or wired connections.

The device 100 may also comprise software elements, shown as being currently located within the working memory 135, including an operating system 140, device drivers, executable libraries, and/or other code, such as one or more application programs 145, which may comprise or may be designed to implement methods, and/or configure systems, provided by embodiments, as will be described herein. Merely by way of example, one or more procedures described with respect to the method(s) discussed below might be implemented as code and/or instructions executable by device 100 (and/or a processor 110 within device 100); in an aspect, then, such code and/or instructions can be used to configure and/or adapt a general-purpose computer (or other device) to perform one or more operations in accordance with the described methods.

A set of these instructions and/or code might be stored on a non-transitory computer-readable storage medium, such as the storage device(s) 125 described above. In some cases, the storage medium might be incorporated within a device, such as the device 100. In other embodiments, the storage medium might be separate from a device (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computerized device 100 and/or might take the form of source and/or installable code, which, upon compilation and/or installation on the device 100 (e.g., using any of a variety of generally available compilers, installation programs, compression/decompression utilities, etc.), then takes the form of executable code.

Application programs 145 may include one or more applications for determining a suitability of an image target for Color Transfer and/or otherwise providing an indication of a suitability of an image target for Color Transfer. It should be appreciated that the functionality of the applications for determining/providing a suitability of an image target for Color Transfer described hereinafter may be alternatively implemented in hardware alone or with hardware using different levels of software, such as an operating system (OS) with suitable hardware, a firmware with suitable hardware, or a computer vision module, etc.

Various example embodiments are described herein which relate to methods and apparatuses for determining/providing a suitability for Color Transfer of an image target that may receive an image target and provide an indication relating to the image targets' suitability for Color Transfer.

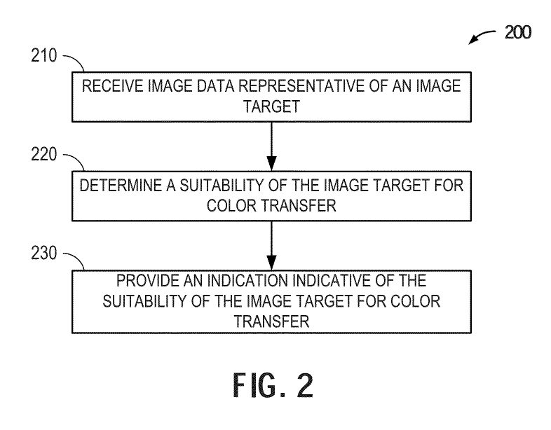

Referring to FIG. 2, a flowchart illustrating an exemplary method 200 for determining/providing a suitability of an image target for Color Transfer is shown. At block 210, image data representing an image target may be received. An image target may be a sill image, or a video frame. Therefore, the image data may be formatted in one of the following formats: JPEG, TIFF, RAW, GIF, BMP, PNG, MPEG, H.263, H.264, etc. The list is illustrative only and is not meant to be exhaustive. The image data may be received or otherwise obtained from memory 135, from one or more storage devices 125, from one or more input devices 115, or from communications subsystem 130. Next, at block 220, the image target's suitability for Color Transfer may be determined. Various methods may be utilized to determine an image target's suitability for Color Transfer. The suitability for Color Transfer may be determined based at least in part on one or more colors present in the image target. More particularly, the determination may be based on one or more of a brightness, hue, saturation, blurriness (e.g., gradient) and/or the like of the image target. One additional particular exemplary method for determining an image target's suitability for Color Transfer is described in detail below. Claimed subject matter, however, is not intended to be so limited. The result of the determination at block 220 may be a numerical value, for example, representing a rating, etc. In certain implementations, a numerical value indicating the image target's suitability for Color Transfer may be normalized. For example, a numerical value may be converted to a more intuitive indication, such as, an N-point (e.g., a 5-point) rating scale such as a star rating scale, a grading scale, etc. For example, in an example five-star rating may indicate that an image target may be determined to be an excellent candidate for Color Transfer, while a zero-star rating may indicate that an image target may be a very poor candidate for Color Transfer. At block 230, the image target's suitability for Color Transfer may be provided. In different embodiments, the suitability may be provided by being caused to be stored in memory 135 or in one or more storage devices 125, displayed on or output by one of the output devices 120, transmitted by communications subsystem 130 to another device, and/or the like or some combination thereof.

In certain example implementations, a Color Transfer technique may determine color changes caused by changes in lighting conditions at sample points selected from image targets based on a Ground Truth image reflecting apparent colors of a real-world scene in a neutral lighting condition, and apply the color changes to the virtual object to make the virtual object appear to have been similarly affected by the changes in lighting conditions. By way of example and not limitation, a color change of a sample point whose color most closely resembles the color of the virtual object may be applied to the virtual object. In the alternative, color changes of multiple sample points may be averaged, and the average color change may be applied to all or part of a virtual object.

Therefore, it should be appreciated that in one embodiment, an exemplary method for determining an image target's suitability for Color Transfer may be based, at least in part, on a number of evenly colored (e.g., having a same color or very close colors) patches present in the image target, a distribution of patches on the image target across multiple scales, a portion of a color gamut covered by colors of patches, a spread of colors of patches across the color gamut, and/or the like or some combination thereof. In one embodiment, an evenly-colored patch may be one or more pixels of a same color or of very close colors forming a closed convex shape. It should be appreciated that a shape that is not closed convex may be subdivided into a set of closed convex shapes.

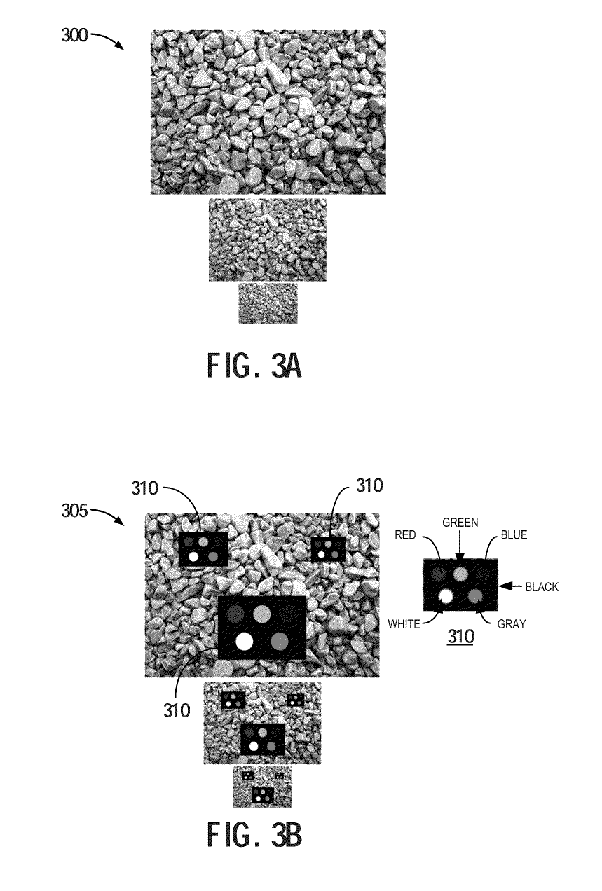

For example, referring to FIGS. 3A and 3B, two exemplary image targets 300 and 305 with different suitability for Color Transfer are shown at three different scales. Compared to image target 300 shown in FIG. 3A, image target 305 shown in FIG. 3B is better suited for Color Transfer techniques because it contains more evenly colored patches (e.g., the single-color red, green, blue, white, grey, and black patches within different-sized black-colored boxes 310) that may be correctly sampled at different scales and collectively cover a broader color gamut. Accordingly, certain example implementations as described herein may determine and therefore indicate that image target 300 has a relatively lower suitability for Color Transfer, while image target 305 has a relatively higher suitability for Color Transfer.

An exemplary algorithm for determining an image target's suitability for Color Transfer based on the number of evenly colored patches present on the image target, the distribution of the patches on the image target across multiple scales, the color gamut covered by the colors of the patches, the spread of the colors of the patches across the color gamut, and/or the like or some combination thereof may be implemented at block 220 of FIG. 2.

By way of example, a suitability value f(I) for an image I is given by the equation

f(I)=Σⱼ₌₁ⁿd(p(c(I,j)),CIELabGamut)×s(p(c(I,j)),CIELabGamut)×r(p(c(I,j)))×q(c(I,j))),

where c(I, k) returns image I at scale level K, q(I) returns the number of evenly colored patches on image I, p(I) returns a list of evenly colored patches on image I with a center of the patch, r(S) returns the amount of pixels covered by patch S, d(S,G) returns the coverage of chromatic samples S on color gamut G wherein a return value of 1.0, for example, indicates all of the possible colors of color gamut G are represented in the samples S, and s(S,G) returns the spread of chromatic samples S on color gamut G wherein a return value of 1.0 indicates samples S are evenly spaced across color gamut G.

It should be appreciated that the suitability value f(I) as described above may be relatively lower for image target 300 of FIG. 3A, and relatively higher for image target 305 of FIG. 3B. As described above, the suitability value f(I) may be further converted into a more intuitive indication (e.g., a star rating, a grade, etc.) at block 220 of FIG. 2. Of course claimed subject matter is not intended to be so limited.

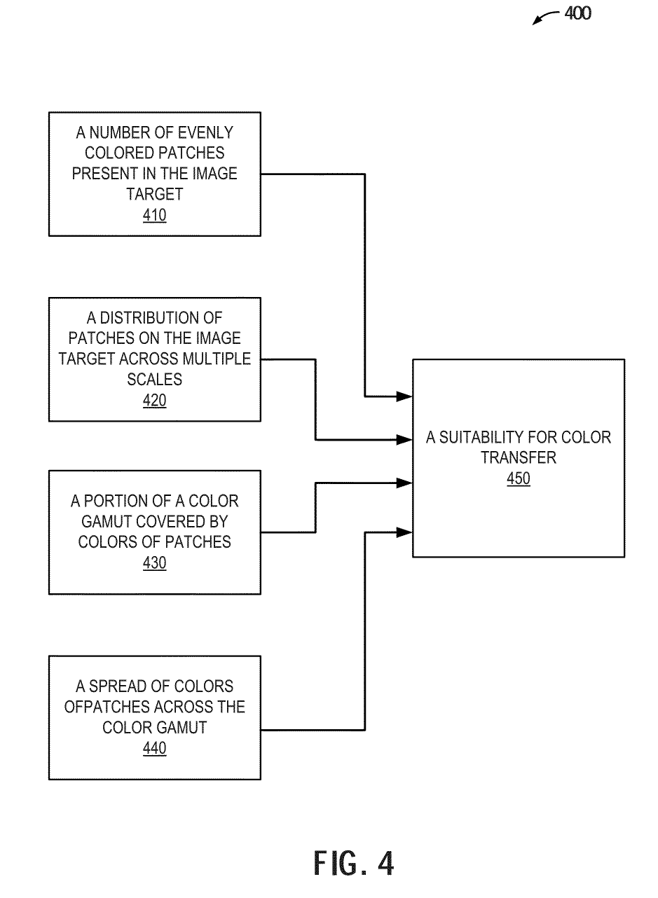

FIG. 4 is a block diagram illustrating example factors that may be considered, at least in part, in determining and providing a suitability for Color Transfer. FIG. 4 illustrates that certain factors mentioned above, such as a number of evenly colored patches present in the image target 410, a distribution of patches on the image target across multiple scales 420, a portion of a color gamut covered by colors of patches 430, a spread of colors of patches across the color gamut 440, and/or the like or some combination thereof, may be utilized in determining for an image target frame a suitability for Color Transfer 450.

Various implementations of methods and apparatuses that may determine a suitability of an image target for Color Transfer have been described in detail. It should be appreciated that such methods and apparatuses, may be implemented as firmware, or hardware and software, or some combination thereof. In one embodiment, the previous described functions may be implemented by one or more processors (e.g., processor 110) of a device 100 to achieve the previously desired functions (e.g., the method operations of FIG. 2).

As may be appreciated, in certain example implementations, an indication of a suitability of an image target for Color Transfer may be provided in some manner so as to indicate to a person that may be developing an augmented reality or other like computer-aided visual application whether a particular image target may be more or less suitable for Color Transfer. Thus, for example, in certain instances, a person may interact with a client device (e.g., a personal computer, a laptop, a tablet, etc.) to identify or otherwise provide one or more image targets to one or more servers or other like devices (which may provide or otherwise support all or part of the techniques present herein). Thus, for example, such a server(s) may provide feedback to the person, via the client device, that may be indicative of a suitability of one or more of the image targets for Color Transfer. Of course, such a client/server relationship is just one of many examples as to how the techniques provided herein may be implemented, and claimed subject matter is not necessarily so limited.

The teachings herein may be incorporated into (e.g., implemented within or performed by) a variety of apparatuses (e.g., devices). For example, one or more aspects taught herein may be incorporated into a general device, a desktop computer, a mobile computer, a mobile device, a phone (e.g., a cellular phone), a personal data assistant, a tablet, a laptop computer, a tablet, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a server, a point-of-sale device, an entertainment device, a set-top box, a wearable device (e.g., watch, head mounted display, virtual reality glasses, etc.), an electronic device within an automobile, or any other suitable device.

In some aspects a wireless device may comprise an access device (e.g., a Wi-Fi access point) for a communication system. Such an access device may provide, for example, connectivity to another network through transceiver (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

It should be appreciated that when the devices are mobile or wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, Advanced LTE, 4G, CDMA, TDMA, OFDM, OFDMA, WiMAX, and WiFi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art would further appreciate that the various illustrative logical blocks, modules, engines, circuits, and algorithm steps described in connection with the embodiments disclosed herein may be implemented as electronic hardware, or a combination of hardware and software. Skilled artisans may implement the described functionality in varying ways for each particular application, but such implementation decisions should not be interpreted as causing a departure from the scope of the present description.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a combination of hardware and software module(s), e.g., executed by a processor. A software module may reside in RAM memory, flash memory, ROM memory, EPROM memory, EEPROM memory, registers, hard disk, a removable disk, a CD-ROM, or any other form of storage medium known in the art. An example storage medium may be coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more example embodiments, the functions described may be implemented in hardware, firmware, or any combination thereof along with software. If implemented in-part using software as a computer program product, the functions or modules may be stored as one or more instructions or code on a non-transitory computer-readable medium. A non-transitory computer-readable medium may be any available medium that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to apply or use the techniques as provided herein. Various modifications to the example embodiments will be readily apparent to those skilled in the art, and the generic principles defined herein may be applied to other embodiments without departing from the spirit or scope of the present description. Thus, claimed subject matter is not intended to be limited to the embodiments shown herein but is to be accorded the widest scope consistent with the principles and novel features disclosed herein.

What is claimed is:

1. A method for providing a suitability for Color Transfer of an image target, the method comprising, with a computing device:
receiving image data representative of the image target;
determining a suitability of the image target for Color Transfer based, at least in part, on one or more colors of the image data; and
providing an indication indicative of the suitability of the image target for Color Transfer.

2. The method of claim 1, wherein the determining of the suitability of the image target for Color Transfer further comprises, with the computing device:
calculating a numerical value indicating the suitability of the image target for Color Transfer; and
normalizing the numerical value to a rating scale.

3. The method of claim 2, wherein the numerical value is normalized to an N-point rating scale.

4. The method of claim 1, wherein the indication comprises a suitability rating.

5. The method of claim 1, wherein the suitability of the image target for Color Transfer is based, at least in part, on:
a number of evenly colored patches present in the image data,
a distribution of the patches on the image target across multiple scales,
a portion of a color gamut covered by colors of the patches,
a spread of the colors of the patches across the color gamut, or
any combination thereof.

6. The method of claim 1, wherein the determining of the suitability of the image target for Color Transfer further comprises analyzing the image data at a plurality of scales.

7. The method of claim 1, wherein the determining of the suitability of the image target for Color Transfer is further based on a brightness, a hue, a saturation, a blurriness of the image target, or any combination thereof.

8. An apparatus for providing a suitability for Color Transfer of an image target, comprising:
a memory; and
a processor to:
receive image data representative of the image target,
determine a suitability of the image target for Color Transfer based, at least in part, on one or more colors of the image data, and
provide an indication indicative of the suitability of the image target for Color Transfer.

9. The apparatus of claim 8, wherein the processor to determine the suitability of the image target for Color Transfer is further to:
calculate a numerical value indicating the suitability of the image target for Color Transfer; and
normalize the numerical value to a rating scale.

10. The apparatus of claim 9, wherein the numerical value is normalized to an N-point rating scale.

11. The apparatus of claim 8, wherein the indication comprises a suitability rating.

12. The apparatus of claim 8, wherein the suitability of the image target for Color Transfer is based on:
a number of evenly colored patches present in the image data,
a distribution of the patches on the image target across multiple scales,
a portion of a color gamut covered by colors of the patches,
a spread of the colors of the patches across the color gamut, or
any combination thereof.

13. The apparatus of claim 8, wherein the processor to determine the suitability of the image target for Color Transfer is further to analyze the image data at a plurality of scales.

14. The apparatus of claim 8, wherein the determining of the suitability of the image target for Color Transfer is further based, at least in part, on a brightness, a hue, a saturation, a blurriness of the image target, or any combination thereof.

15. An apparatus for providing a suitability for Color Transfer of an image target, comprising:
means for receiving image data representative of the image target;
means for determining a suitability of the image target for Color Transfer based, at least in part, on one or more colors of the image data; and
means for providing an indication indicative of the suitability of the image target for Color Transfer.

16. The apparatus of claim 15, further comprising:
means for calculating a numerical value indicating the suitability of the image target for Color Transfer; and
means for normalizing the numerical value to a rating scale.

17. The apparatus of claim 16, wherein the numerical value is normalized to an N-point rating scale.

18. The apparatus of claim 15, wherein the indication comprises a suitability rating.

19. The apparatus of claim 15, wherein the suitability of the image target for Color Transfer is based, at least in part, on:
a number of evenly colored patches present in the image data,
a distribution of the patches on the image target across multiple scales,
a portion of a color gamut covered by colors of the patches,
a spread of the colors of the patches across the color gamut, or
any combination thereof.

20. The apparatus of claim 15, further comprising means for analyzing the image data at a plurality of scales.

21. The apparatus of claim 15, wherein the determining of the suitability of the image target for Color Transfer is further based, at least in part, on a brightness, a hue, a saturation, a blurriness of the image target, or any combination thereof.

22. An article for use with an electronic device, the article comprising:
a non-transitory computer-readable medium comprising code that is executable by a processor of the electronic device to:
receive image data representative of an image target;
determine a suitability of the image target for Color Transfer based, at least in part, on one or more colors of the image data; and
provide an indication indicative of the suitability of the image target for Color Transfer.

23. The article of claim 22, wherein the code is further executable by the processor to:
calculate a numerical value indicating the suitability of the image target for Color Transfer; and
normalize the numerical value to a rating scale.

24. The article of claim 23, wherein the numerical value is normalized to an N-point rating scale.

25. The article of claim 22, wherein the indication comprises a suitability rating.

26. The article of claim 22, wherein the suitability of the image target for Color Transfer is based on:
a number of evenly colored patches present in the image data,
a distribution of the patches on the image target across multiple scales,
a portion of a color gamut covered by colors of the patches,
a spread of the colors of the patches across the color gamut, or
any combination thereof.

27. The article of claim 22, wherein the code is further executable by the processor to analyze the image data at a plurality of scales.

28. The article of claim 22, wherein the code is further executable by the processor to:
determine the suitability of the image target for Color Transfer based, at least in part, on a brightness, a hue, a saturation, a blurriness of the image target, or any combination thereof.
